(19) United States
(12) Patent Application Publication
(10) Pub. No.: US 2013/0036001 A1
(43) Pub. Date: Feb. 7, 2013

(54) SYSTEM FOR AN INTEGRATED MULTI-VENDOR CUSTOMER LOYALTY AND TARGETED MARKETING PROGRAM AND METHOD FOR ITS USE

(71) Applicants: Brian Wegner, Zionsville, IN (US); Ryan Wegner, Murrieta, CA (US)

(72) Inventors: Brian Wegner, Zionsville, IN (US); Ryan Wegner, Murrieta, CA (US)

(73) Assignee: Triliant, LLC, Zionsville, IN (US)

(21) Appl. No.: 13/567,348

(22) Filed: Aug. 6, 2012

Related U.S. Application Data
(60) Provisional application No. 61/515,665, filed on Aug. 5, 2011.

(51) Int. Cl. G06Q 30/02

(52) U.S. Cl. 705/14.31; 705/14.27

(57) ABSTRACT

A system for an integrated multi-vendor customer loyalty and personalized marketing program and a method for its use are disclosed. The system comprises at least one database server operably connected to a plurality of external vendor servers and a plurality of devices at many disparate points of sale, whereby sales transactions are processed and communicated to the system's on-line transaction processing database, reward and eligibility determinations are made, consumers are credited immediately for various factors relating to the sales transactions by each participating vendor (i.e., merchant or CPG) involved in the transaction, and separate credit balances are maintained in vendor-specific subaccounts for that particular consumer. The method involves the creation of a single, centralized consumer account to which the system automatically allocates and applies credits to individual vendor-specific subaccounts by dividing and segregating the credits for any given sales transaction.

### CROSS-REFERENCE TO RELATED APPLICATIONS

This application claims the benefit of U.S. Provisional Patent Application No. 61/515,665, filed Aug. 5, 2011, the contents of which are hereby incorporated by reference.

### TECHNICAL FILED OF THE DISCLOSURE

The presently disclosed embodiments generally relate to customer loyalty and targeted marketing programs and, more particularly, to multi-vendor customer loyalty and targeted marketing programs.

### BACKGROUND

Businesses continually seek new customers and also seek return business from customers they already have. At the same time, consumers are increasingly seeking value and discounts from their purchases. One means of meeting these demands is with consumer loyalty programs. Generally, a customer loyalty program (or “reward” program) tracks the purchases of goods or services by individual consumers and applies credits to a consumer's personal account for the amount, value, or frequency of those purchases. These credits may take the form of points, currency, product discounts, pre-paid gift cards, or other benefits provided by a consumer products company (“CPG”) or by a retailer of goods or services (“merchant”), known collectively as “vendors.” Such loyalty programs are common among such service providers as commercial airlines and such retailers as grocery and apparel stores.

The benefits of such programs to a business include the opportunity to build repeat business, or cross promote products and services, as well as the ability to track purchases and sales trends. However, reward programs often are ineffective at drawing in new customers, because most are unaware of the program until they become a customer. Further, the cost of supporting technology systems and business processes to track consumers' purchases, set up new customers in a business' individual system, produce rewards cards, produce reports on consumer activity, update consumers' accounts, etc. can become a significant barrier for most businesses to establish and operate quality loyalty programs. Another problem of loyalty programs is that consumers often have so many loyalty cards that an individual business loses visibility as cards are buried in purses or wallets, are stored away, or are lost. The inconvenience of carrying multiple cards and the need to enroll at each business with a loyalty program reduce the value of many programs to consumers. Finally, in most cases consumer products companies have no effective or efficient method of offering a customer loyalty program because their distribution channel flows through the retailer.

### SUMMARY OF THE DISCLOSED EMBODIMENTS

In one embodiment, a system for an integrated multi-vendor customer loyalty program for use with a point of sale terminal operative to record sales transaction data relating to a customer purchase is disclosed, the system comprising: a terminal device disposed near the point of sale terminal; a wireless local area network; a software adaptor executed by a data processor, the software adaptor operative to retrieve the sales transaction data and transmit the sales transaction data to the terminal device; at least one database server comprising operational software and a plurality of consumer accounts and operably connected to the terminal device; and a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts; wherein the terminal device is operative to transmit the sales transaction data in real-time over the wireless local area network to the at least one database server to be recorded in at least one of the plurality of databases.

In another embodiment, a system for an integrated multi-vendor customer loyalty program for use with a point of sale system operative to record product level sales transaction data relating to a customer purchase of a market basket of goods/services, wherein the customer has a program status, is disclosed, the system comprising: at least one database server comprising operational software and a plurality of consumer accounts; a software adaptor executed by a data processor, the software adaptor operative to retrieve the product level sales transaction data and transmit the product level sales transaction data to the at least one database server; and a plurality of databases on the at least one database server configured to manipulate and store the product level sales transaction data, to store operating parameters of a plurality of vendors' loyalty programs, determine the customer's offer and reward eligibility under the operating parameters given the customer program status and contents of the market basket, transmit back to the point of sale system, prior to completion of the customer purchase, offers and rewards for which the customer is eligible, and updating individual vendor-specific subaccounts linked to the customer to reflect the customer purchase.

In another embodiment, a method for using an integrated multi-vendor customer loyalty program in conjunction with a point of sale terminal operative to record sales transaction data relating to a customer purchase is disclosed, the method comprising the steps of: a) providing: a terminal device disposed near the point of sale terminal; a wireless local area network; a software adaptor executed by a data processor, the software adaptor operative to retrieve the sales transaction data and transmit the sales transaction data to the terminal device; at least one database server comprising operational software and a plurality of consumer accounts and operably connected to the terminal device; and a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts; wherein the terminal device is operative to transmit the sales transaction data in real-time over the wireless local area network to the at least one database server to be recorded in at least one of the plurality of databases; b) recording the sales transaction data in a data mining and analytics database; c) a first one of the plurality of vendors retrieving from the data mining and analytics database sales transaction data relating to a purchase of a second one of the plurality of vendors' products.

In another embodiment, a method for using an integrated multi-vendor customer loyalty program in conjunction with a point of sale terminal operative to record sales transaction data relating to a customer purchase is disclosed, the method comprising the steps of: a) providing: a terminal device disposed near the point of sale terminal; a wireless local area network; a software adaptor executed by a data processor, the software adaptor operative to retrieve the sales transaction data and transmit the sales transaction data to the terminal device; at least one database server comprising operational software and a plurality of consumer accounts and operably connected to the terminal device; and a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts; wherein the terminal device is operative to transmit the sales transaction data in real-time over the wireless local area network to the at least one database server to be recorded in at least one of the plurality of databases; b) recording the sales transaction data in one of the plurality of databases; c) establishing a predetermined rule in which a reward is given to a customer after the customer makes a predetermined number of predetermined purchases within a predetermined time period; d) for each current customer purchase, analyzing in real-time sales transaction data from the current customer purchase and recorded sales transaction data from past customer purchases to determine if a reward has been earned under the predetermined rule; and e) if a reward is determined at step (d) to have been earned, applying the reward in real-time to the current customer purchase.

In another embodiment, a method for using an integrated multi-vendor customer loyalty program in conjunction with a point of sale terminal operative to record sales transaction data relating to a customer purchase of a supplier's product from a merchant is disclosed, the method comprising the steps of: a) providing: a terminal device disposed near the point of sale terminal; a wireless local area network; a software adaptor executed by a data processor, the software adaptor operative to retrieve the sales transaction data and transmit the sales transaction data to the terminal device; at least one database server comprising operational software and a plurality of consumer accounts and operably connected to the terminal device; and a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts; wherein the terminal device is operative to transmit the sales transaction data in real-time over the wireless local area network to the at least one database server to be recorded in at least one of the plurality of databases; b) recording the sales transaction data in one of the plurality of databases; c) establishing a predetermined rule in which a reward is given to a merchant for purchases by customers of a predetermined number of the supplier's product; d) for each current customer purchase, analyzing sales transaction data from the current customer purchase and/or recorded sales transaction data from past customer purchases to determine if a reward has been earned under the predetermined rule; and e) if a reward is determined at step (d) to have been earned, applying the reward to an account for the merchant in one of the plurality of databases.

Other embodiments are also disclosed.

### BRIEF DESCRIPTION OF THE DRAWINGS

The features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 shows a schematic view of a system for an integrated multi-vendor customer loyalty and targeted marketing program, according to at least one embodiment of the present disclosure;

FIG. 2 shows a process flow diagram of a system for an integrated multi-vendor customer loyalty and targeted marketing program, illustrating the parties using and interacting with the system, according to at least one embodiment of the present disclosure; and

FIG. 3 shows a schematic view of a point of sale system for implementing a multi-vendor customer loyalty and targeted marketing program, according to at least one embodiment of the present disclosure.

Like reference numerals indicate the same or similar parts throughout the several figures.

An overview of the features, functions and/or configuration of the components depicted in the various figures will now be presented. It should be appreciated that not all of the features of the components of the figures are necessarily described. Some of these non-discussed features, such as various connection protocols, connectivity applications, etc., as well as discussed features are inherent from the figures. Other features not discussed may be inherent in component architecture or configuration.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. Nevertheless, it will be understood that no limitation of the scope of this disclosure is thereby intended.

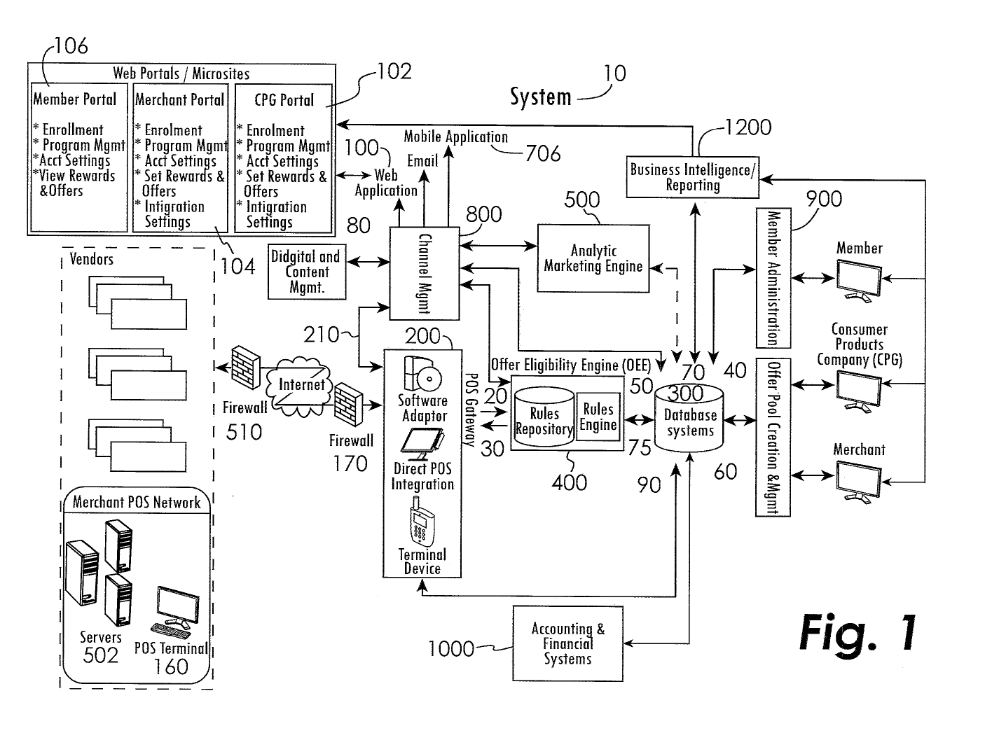

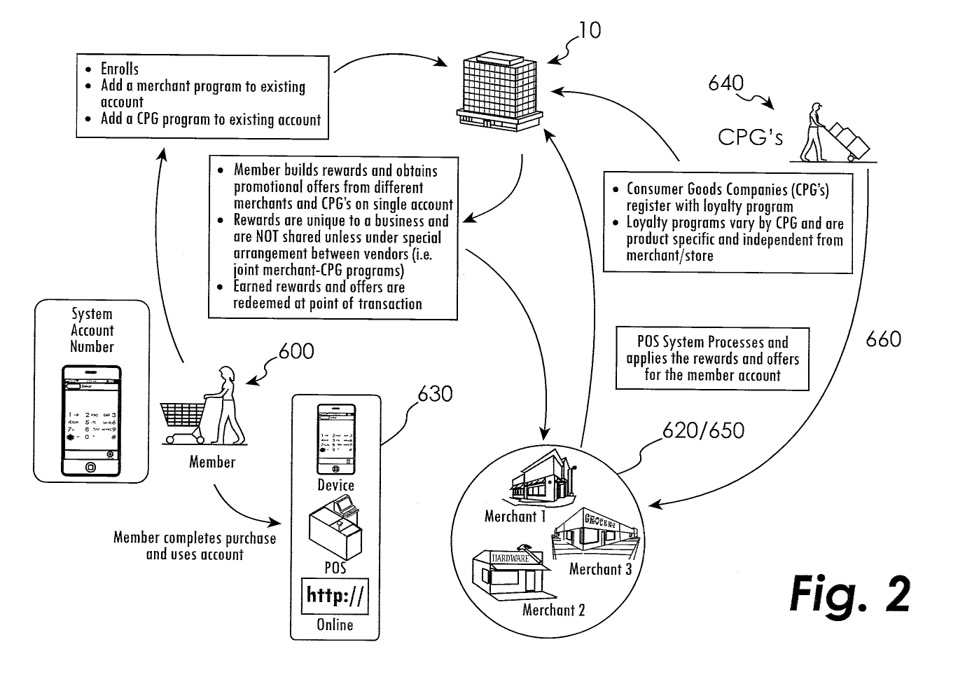

The present disclosure includes disclosure of a system for an integrated multi-vendor customer loyalty and marketing program and a method for its use. FIGS. 1 and 2 show a schematic view of at least one embodiment of a system according to the present disclosure. Shown in FIG. 1 is system 10 comprising an on-line transaction processing database and servers 300 operably connected to a loyalty system 400 and marketing engine 500 and to a plurality of external devices and users via a member administration interface 900, offer creation facility 700, and channel management interfaces 800. System 10 further comprises a dedicated content management system 100, a vendor accounting and financial system 1000, an analytic reporting system 1200, a plurality of vendor servers 500, and a plurality of vendor points of sale (“POS”) 160, operably connected by system interface 200.

The database systems and servers 300 comprises a transaction database 75, reporting and analytics database 70, data processing and database servers that manage the key functionality of the system 10 and contains the consumer loyalty database 40, the consumer purchase database 50, the business database 60, the customer relationship management (“CRM”) system 90, and an agent commission and relationship system (not shown in FIG. 1). The consumer loyalty database 40 comprises, for example, consumer account information, including at least an account number, demographic information for the consumer, and whether and to which family or group the consumer belongs. Because it is accessed by vendors 660 (CPG's 640 and merchants 650 will be collectively referred to herein as “vendors 660” when appropriate) at the time of a transaction, the consumer loyalty database 40 contains no direct personal identifiers other than account number. In addition, the consumer loyalty database 40 records the vendors 660 with which the consumer is enrolled in a loyalty program and the dates of enrollment. Further, the consumer loyalty database 40 tracks by vendor such data as credit and offer pool status, gift card balances, current and prior quarter credits activity, and last activity date, and tracks by industry such data as consumer preferences.

The consumer purchase database 50 comprises a transactional database that records the product codes and descriptions (such as SKU and/or UPC numbers, to name just two non-limiting examples), date and timestamps, and vendor data for each consumer purchase and enables the market research and data mining activities of the data mining and analytics database (“DMAD”) 70 (described in greater detail hereinbelow). The business database 60 supports the definitions for each vendor 660, including at least contact and billing information, store details, reward program details including program levels and award details, product and service offerings, and billing information. The business database 60 also records the services for which the vendor 660 is enrolled, including at least data analytics on their own business, data analytics on multi-dimensional sales and demographic data, on-line advertising, e-mail advertising, response rates, and their customer purchase behavior. The CRM system 90 contains all consumer personal and account information, including at least contact information, such as name, mailing address, email address, and phone numbers, other personal attributes, account log-in, password, and a contact log for recording the purpose, date, and other information related to phone inquiries. In at least one embodiment of a system according to the present disclosure, the database system 300 comprises the backup and recovery system (not shown in FIG. 1) that allows restoration of system operations upon primary system failure, and the account representative commission and relationship system (also not shown in FIG. 1) that enables a system host company to track, appoint, and pay commissions to account representatives that sell the system 10 services to vendors 660.

The system interface 200 comprises one or more applications running on the system servers 300, including at least a transaction processor 20, an automatic enrollment system 30, a services layer 210, a dedicated website and personalized microsites 100, and an advertising portal 80. The system interface 200 provides interfaces and portals to the system 10 for such system users as consumers 600, CPGs 640, and merchants 650. Additionally, the system interface 200 interfaces with at least one vendor server 502 via a secure, Transmission Control Protocol and Internet Protocol (TCP/IP) network connection over a public computer network, such as the Internet, through a firewall 510, and utilizing a load balancer (ELB) to route and balance the workload between the system 10's web-servers receiving each client request from the point of sale.

The transaction processor 20 interfaces with at least one merchant POS system 160 via a secure, TCP/IP network connection over a public computer network, such as the Internet, through one or more firewalls 170 and records the relevant details of each transaction to the database systems 300 and loyalty eligibility system, as established by specific merchant integration settings. In at least one embodiment of the present disclosure, the transaction processor 20 is available twenty-four hours a day every day of the year.

In at least one embodiment of a system according to the present disclosure, the system interface 200 comprises an automatic enrollment tool 30 that enables the immediate enrollment of a consumer 600 into a vendor's loyalty program when a valid means of consumer identification is entered at a POS 160 where the consumer 600 is not yet enrolled. The automatic enrollment tool 30 can enable an enrollment process transparent to the consumer 600 while notifying the vendor 660 that this is a new consumer.

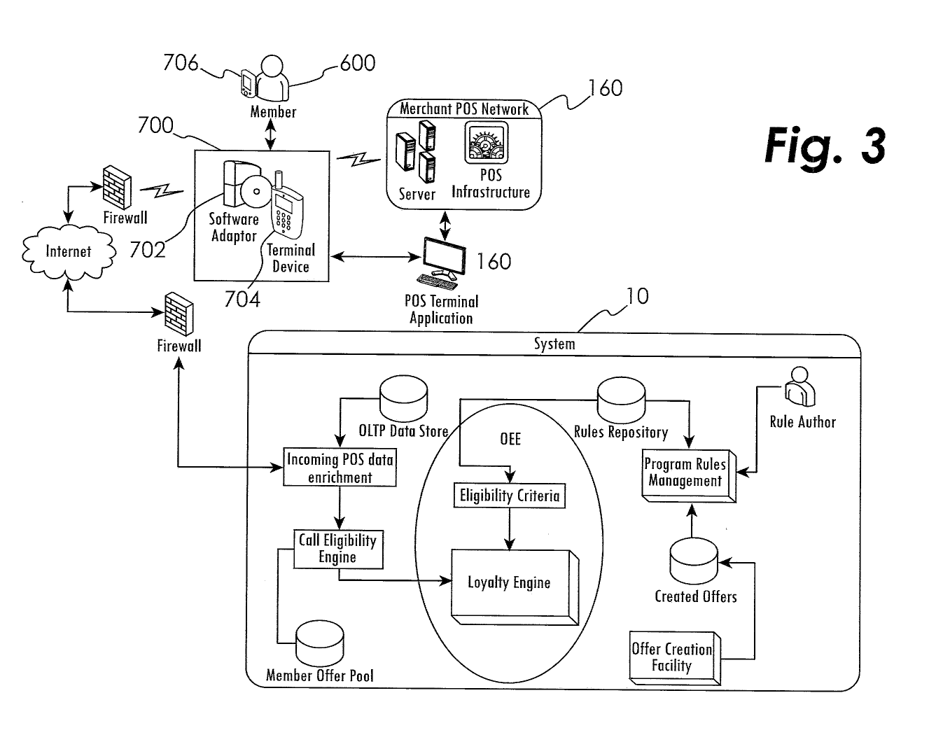

With reference to FIG. 3, the system 10 includes a POS gateway 700 resident at each business location and operating with the POS 160 network. The POS gateway 700 may include in some embodiments a software adaptor 702 and a terminal device 704. In some embodiments, the adaptor 702 comprises a proprietary and representational state transfer application programming interface (REST API). The adaptor 702 is pre-loaded into terminal device 704 with remote configuration. The terminal device 704 is connected to the POS terminal 160 by any convenient means, such as through a universal serial bus (USB) or wirelessly using an appropriate standard, such as Bluetooth. The terminal device 704 uses the adaptor 702 to extract sales transaction data from the POS terminal 160 and send real-time transaction data to the system 10 for processing and receives communications back from the system 10. In some embodiments, the adaptor 702 extracts product-level purchase information in support of real time processing at the point of sale, including, but not limited to: product identification (SKU, UPC, or other codes that identify the specific product purchased), item unit quantity, item unit price, timestamp, merchant location details, and transaction totals. For example, after the system 10 verifies eligibility, the system 10 will send a response back to the adaptor 702 to apply offers/rewards and complete the redemption process. Because each POS system 160 provides different integration points, inventory management systems and proprietary operating systems, the adaptor 702 may be specific to a given POS system 160 type. In some embodiments, the adaptor 702 may be programmed directly into the POS system 160 without the implementation of the terminal device 704. In web-based sales environments, the adaptor 702 may be integrated into the software of the web-based merchant.

In some embodiments, the terminal device 704 is a small handheld terminal platform that serve as the interface between members/consumers 600, the merchant POS system 160, and the system 10 for in-store purchases. The terminal device 704 accesses a wireless local area network (Wi-Fi network) wirelessly to support real-time data exchange with the external system 10 at the point of sale. The terminal device contains the adaptor 702 software to integrate with POS system 160 (and may have access to the merchant's SKU, UPC or other 3rd level product data). The system 10 may access the terminal device 704 remotely to configure, activate, and troubleshoot the system 10, the terminal device 704, and connections to the POS 160.

The member 600 may identify themselves as members in many ways, such as by presenting a card, an identification number, or using a mobile phone application (app) 706. The mobile phone app 706 may support several functions on the member 600's smart phone:

a. Presents their system 10 identification code at point of sale (e.g. phone number) or by mobile app 108 scanning (e.g., a visible code such as a 2d or 3d barcode, sound-based communication, or through near field communication (NFC)) at time of purchase;

b. Search for offers by vendor category (type of restaurant, grocery store, etc.), vendor name, by offer/reward type, and/or by location based on an entered location or current phone GPS signal;

c. Receive marketing offers via e-mail;

d. Log into their consumer portal 106 to view account status and offers.

In some embodiments, the terminal device 704 serves as the medium for previously-enrolled consumers 600 to scan their mobile phones (through a custom app 706 associated with the system 10), swipe an identification card, or enter other identification numbers (such as a telephone number) for member 600 recognition by the system 10. In other embodiments, consumers can supply their program identification number, such as their phone number, to the merchant for entry into the POS system. For a consumer 600 not yet enrolled in a loyalty program associated with the merchant, the terminal device 704 allows the consumer 600 to begin the enrollment process, such as, for example, by entering a new phone number into the terminal device 704. The terminal device 704 then interfaces with the system 10 and the POS 160 to create a temporary account for the consumer 600 immediately, so the consumer 600 can begin earning rewards and redeeming offers in same visit. The customer may complete their registration process at a later time via an online (web-based) registration interface. An account is established by the merchant (e.g. cashier) entering the desired account number (such as a telephone number) into terminal device 704 or other POS interface, which sends a request to the system 10 to be processed. A response is sent back from the system 10 to the terminal device 704 with an affirmation that this is a new account. Alternatively, a “no” response would require the entry of a different account number.

In some embodiments, a less expensive, mobile version of the terminal device 704 may be used that works in conjunction with one fully-functional terminal device 704 to decrease costs. In this case, a primary terminal device 704 contains fully functioning adaptor software, and remaining devices relay information to and from the primary device and the merchant's POS system infrastructure. For example, in a restaurant setting, the wait staff may carry mobile versions of the terminal device 704 to the diner's table, and the mobile version may interact with a fully-functional terminal device 704 integrated with a centrally located POS terminal. If the adaptor software 702 resides inside the merchant's POS network 160, then not all devices need this capability.

In some embodiments, Wi-Fi (wireless fidelity) networks are maintained at each merchant location to support web-based system 10 deployment. Such Wi-Fi networks can be supported through the merchant's internet connection or through an independent connection/device that interfaces to the merchant's POS system. These Wi-Fi networks enable HTTP request communication between the system 10 and the adaptor 702 through the terminal device 704 and system web-servers.

The system interface 200 also comprises a services layer 210, which comprises a dedicated website 100, to be accessed via a TCP/IP connection to a public computer network, such as the Internet, a CPG portal 102, a merchant portal 104, and a consumer/member portal 106. The CPG portal 102 enables a CPG 640 to perform a plurality of system functions including, but not limited to, registering an account on the system 10, configuring that account and manage account settings, manage user permissions, submit service requests, identifying its affiliated stores 620, establishing the operating parameters of its particular rewards program (called “reward rules”), accessing its sales data and business intelligence reporting, view accounting information, making adjustments according to consumer activity, accessing data mining tools, create general marketing offers, place orders for analytics-driven targeted marketing campaigns, and configuring the POS integration settings for sharing information with merchants 650. All information and settings entered via the CPG portal 102 are stored in the business database 60. Similarly, the merchant portal 104 enables a merchant 650 to register an account on the system 10, configure that account and manage account settings, manage user permissions, submit service requests, identify its affiliated stores 620, establish and manage the reward rules of its particular rewards program(s), access its sales data and business intelligence reporting, view accounting information (i.e. CPG owes merchant $x this month for redeeming CPG rewards), make adjustments according to consumer activity, access data mining tools, create general marketing offers, place orders for analytics-driven targeted marketing campaigns, and configure the POS integration settings for sharing information with CPGs 640, among other functions. Information and settings entered via the merchant portal 104 are stored in the system databases, including business database 60, the customer loyalty database 40, the consumer purchase database 50, and the data mining and analytics database 70. Businesses may establish a collective web portal for each location, or vary those pages through any number of business tiers (such as location, franchise, region, corporate, etc.) with security permissions throughout.

The consumer portal 106 enables a consumer 600 to create an account on the system 10, access that account via a secure connection to monitor activity and award status, purchase gift cards, and redeem the benefits that have accumulated with each participating merchant and CPG, receive and view promotional offers, manage rewards and offers, add favorite businesses, search for participating businesses and view loyalty programs, receive alerts (such as upcoming expiration dates of rewards or other notices), change account settings and details, enroll and un-enroll from any business program, and view multi-dimensional reports for their account, among other functionality.

All information and settings entered via the consumer portal 106 are stored in the CRM system 90. In at least one embodiment of the disclosure, the website 100 supports multiple primary languages to be used by consumers, CPGs, and merchants in various countries via the Internet. Additionally, the website 100 provides users with information about the host company and about the services and benefits offered by the system 10.

In at least one embodiment of a system according to the present disclosure, the system interface 200 comprises an automated interactive voice response phone system (not shown in FIG. 1) for receiving and processing technical support request calls from users. The automated phone system uses voice recognition capabilities to enable users to inquire about account balances and other account information. Further, the automated phone system can recognize the phone number of the caller to identify the account (if it is a listed phone number), to greet the caller and respond in the appropriate language, and to route the call to a service representative who speaks the language of the caller.

In at least one embodiment of a system according to the present disclosure, the system interface 200 comprises an advertising portal 80 that enables vendors 660 to design advertising for targeted consumer marketing campaigns, including at least branding, images, and messages, based on consumer data stored on the data warehouse server 400. The advertising portal 80 interfaces with email and sms messaging providers (not shown in FIG. 1) to distribute the targeted marketing materials to consumers 600.

The database system and servers 300 provide primary data storage for the system 10 and comprises a data mining and analytics database (“DMAD”) 70 and a reporting system 1200. The DMAD 70 enables vendors 660 to analyze detailed consumer information for market research and to access sales information for other vendors by demographic and product type with or without corresponding individual consumer and vendor identification. The reporting system 1200 comprises business intelligence software that provides an interface to system users via a secure network connection over a public computer network, such as the Internet, through a firewall.

The reporting system 1200 enables predefined reports on demand for vendors to access, including at least consumer activity (with personal identification, if desired) and activity by product. The reports may be viewed and printed online or downloaded from the vendor portals (104, 102) for a user's own analysis. Likewise, the reporting system 1200 enables consumers 600 to review the balances of their accounts with each vendor, as well as gift card balances and historical sales transaction details, view current and prior quarter point activity by vendor, and view the awards, award levels, and points needed to attain a particular level.

While FIG. 1 shows a schematic view of at least one embodiment of a system for an integrated multi-vendor customer loyalty program according to the present disclosure, the embodiments are merely offered by way of non-limiting examples of the disclosure described herein. The system according to the present disclosure comprises a centralized and integrated system enabling vendors to allocate and apply credits to an individual consumer in separate accounts by dividing and segregating the credits for a given transaction into separate vendor-specific subaccounts for that particular consumer. Further, the system enables a consumer to use a single means of identification in a sales transaction to earn credits from all participating vendors and to keep those credits segregated by vendor.

The system according to the present disclosure enables a consumer to create a single, centralized account on the system using various means, such as a computer network or a telephone system, and then register in any participating vendors' loyalty programs by either enrolling through the consumer web portal 106, or simply using that system account in a sales transaction with a participating vendor. Once registered, the system uses transactional information from each sale to automatically credit the consumer in separate vendor-specific subaccounts for each vendor involved in that particular transaction. For example, the system may use the vendors' predetermined rules, along with the consumer's current offer pool (available rewards and offers), current transaction market basket (items being purchased) and current loyalty program status to determine which offers the consumer qualifies for and sends the offers and/or rewards back to the POS terminal to be applied. For example, assume the consumer is purchasing a 32 ounce bottle of BRAND ABC dishwashing detergent and other food items in the current transaction totaling $52. A predetermined merchant rule in the system may state that a consumer at the “gold level” (based on money spent with this vendor in the preceding 12 months) is entitled to 10% off of the purchase total when spending $50 or more (for example, where Platinum level entitles the consumer to 15% off any purchase of $50 or more, Gold level=15% off $50 or more purchase, and Silver level=5% off $50 or more purchase). Additionally, the ABC-linked CPG program is offering $2.50 off when purchasing a 32 ounce bottle of BRAND ABC dishwashing detergent (in essence an electronic coupon). The system would automatically apply the 10% merchant program discount to the total, and would then discount the $2.50 from the ABC CPG program (on top of, but separate from, the 10% discount from merchant program) at the POS terminal based upon an adjudication of the consumer's offer pool (current program status and available offers/rewards) and the consumer's market basket (at SKU/UPC product level). Consumers may be credited based on a wide variety of factors, including their status in the program, individual products and services purchased, number of visits to a merchant (or number of visits during a predefined time period), aggregate purchase dollar totals over time, purchase dollar total for a particular transaction, etc. Any factor that a merchant or supplier wishes to consider as a basis for awarding a credit or offer is supported by the ability of the vendors to establish their own predetermined rules. In at least one embodiment of a system according to the present disclosure, the system can process transactions occurring directly between a consumer and a non-retail CPG. In this manner, the system provides CPGs an effective and efficient method of offering a customer loyalty program for non-retail CPGs directly to consumers.

While the system is designed to enable the segregation of credits by vendor, the system may enable sharing of credits as allowed by the participating vendors and consumers. Likewise, because the system comprises a centralized repository of all consumer transactional information, consumers and vendors are enabled to review, analyze, manipulate, compile, and use this aggregated data to understand buying behavior, develop direct marketing strategies, and cross-market in cooperation with other vendors. In addition, the integrated system enables vendors to provide the benefits or rewards of their loyalty program at the point of sale without cumbersome and expensive coupons, vouchers, gift cards, or the like. By pulling a consumer's accumulated reward status from the system, vendors can apply discounts or other benefits directly to the consumer based on each distinct transaction. Thus, the system enables the integration of consumer transactional information and the flexible use of that information to provide valuable services to all users, consumers, merchants, and CPGs.

To further illustrate, FIG. 2 shows a process flow diagram of a system for an integrated multi-vendor customer loyalty program, illustrating the parties using and interacting with the system, according to at least one embodiment of the present disclosure. For ease of understanding, the steps of the related methods described herein will be discussed relative to components of the system 10 shown in FIG. 1, but it will be appreciated that any such system can be used to perform these methods so long as it has a server, various applications to receive electronic communications and can be programmed to execute the necessary steps. As shown in FIG. 2, a consumer 600 can register an account on the system 10 by using the consumer portal 106 and may be issued a “rewards card” via the card printing services (not shown in FIG. 1) and an account number. A rewards card may be any valid means of consumer identification and may take the form of a plastic card with a magnetic strip on one side to record the necessary consumer account information. Other valid means of consumer identification may include, but not be limited to, a personal application on the consumer's mobile phone, a radio frequency identification device, a consumer's email address, or a consumer's telephone number. Once an account has been established, the consumer 600 may be automatically enrolled in any participating vendors' loyalty programs via the automatic enrollment system 30 whenever the consumer's account and pin is used at a participating vendor's store 620 that is equipped with a capable POS system 160. Vendor's store 620 may be a physical retail location, a telephone call center, an on-line website, or another means of processing and executing sales transactions.

When consumers 600 use their account to purchase goods or services, for example by either entering valid means of consumer identification in an on-line transaction or using their mobile app for an on-site transaction, transactional information 630 is created, which can include at least the product codes and descriptions, dates and times, and vendor details (e.g. vendor(s) name, store location id, cashier etc.) of the goods or services purchased. The transaction processor 20 automatically transmits the transactional information 630 to the consumer purchase database 50, where the loyalty system 400 determines offer and reward eligibility and credits the consumer's account for the value of the transaction according to the reward rules stored in the business database 60 as established by the vendor 660 via the CPG portal 102 or merchant portal 104, as applicable. The database systems and servers 300 share this transactional information 630 from the consumer purchase database 50 with the consumer loyalty database 40, which segregates the points earned by the consumer 600 for the transaction by vendor 660. The database server 300 can share the transactional information with vendors' servers 500 involved in the transaction but will not share transactional information between servers from different vendors 660 unless so established by prior agreement between vendors 660 as recorded in the business database 60. Similarly, consumer information stored in the consumer loyalty database 40 is not shared between the servers 500 of different vendors 660 unless so established by prior agreement by the consumer 600 (as recorded in the CRM database 90) or between vendors 660 (as recorded in the business database 60).

In at least one embodiment of a system according to the present disclosure, unlike prior art systems, the system 10 can process transactions occurring directly between a consumer 600 and a CPG 640, that is, transactions not involving a merchant 650. An example of such a transaction may be where a consumer 600 purchases a soft drink at a vending machine 620 equipped with a proper POS system 160, or where a consumer purchases a product or service directly from the CPG's website. In this manner, unlike previous loyalty program systems, the system 10 provides CPGs 640 an effective and efficient method of offering a customer loyalty program to consumers 600. Further, CPGs 640 have direct access to consumers' transactional information 630 via the business reporting system 110 and the DMAD 70, without being filtered through a merchant 650 as in prior art systems.

In at least one embodiment of a system according to the present disclosure, consumers 600 can earn credits (e.g. loyalty rewards and marketing offers) from more than one vendor 660 for a given transaction. For instance, a transaction may involve a product from a CPG 640 and a retail merchant 650 selling the product. The consumer 600 could earn credits from both the CPG 640 and the merchant 650 for that same transaction. In such a case, after offer eligibility is determined by the loyalty system 400, the database servers 300 shares the transactional information 630 from the consumer purchase database 50 with the consumer loyalty database 40, which records the credits earned from the transaction to the proper consumer accounts under each vendor 660 involved. For example, a consumer 600 may be shopping at a grocery store merchant 650 that has implemented a loyalty program under the multi-vendor customer loyalty program described herein. Therefore, the consumer 600 will earn credits for shopping with the merchant 650 according to the business rules that the merchant 650 has established. Additionally, a consumer goods company (also known as CPG) 640, such as BRAND XYZ COLA, may also have implemented a loyalty program under the multi-vendor customer loyalty program. According to business rules entered into the system by BRAND XYZ COLA, a certain number of credits will be applied to the account of any consumer that purchases a 24-pack of BRAND XYZ COLA during the current month. If the consumer 600 purchases a 24-pack of BRAND XYZ COLA, the consumer 600 will receive credits from both the merchant 650 and the CPG 640 for the same purchase, and these credits will be automatically applied by the system 10 according to its stored business rules so long as the consumer 600 identifies himself as a member of the loyalty program at the time of the transaction.

In at least one embodiment of a system according to the present disclosure, consumers 600 can redeem benefits at any store 620 with a properly-equipped POS 160 by using the mobile application 706. The transaction processor 20 pulls information related to a consumer's program status and available offer pool from the consumer loyalty database 40 and can apply discounts or other benefits from the vendors 660 involved directly to the transaction. In this manner, unlike prior art systems, the system 10 enables vendors 660 to more efficiently provide reward benefits to consumers at lower cost to the vendor 660.

In at least one embodiment of a system according to the present disclosure, the balances of gift cards issued by vendors 660 may be tracked using the consumer loyalty database 40 as transactions are processed by the transaction database server 300 and accessible to the consumer 600 via the consumer portal 106 and reporting system 1200. Further, consumers 600 can collectively earn and aggregate benefits as a member of a family or group with participating vendors 660.

In at least one embodiment of a system according to the present disclosure, the database system and servers 300 can enable vendors 660 to design and distribute advertising and other marketing materials directly to consumers 600 via the advertising portal 80 by pulling consumer information and preferences from the consumer purchase database 50 and combining it with information from business database 60 and the reporting system 1200. Marketing materials can be accompanied by any type of offer desired by the vendor 660, who may choose to offer discounts, preferred customer treatment, or any other promotion that fits their business model.

It will be appreciated from the above description that the system 10 integration to the merchant POS 160, and the real-time data transfer between these systems while the sale is on-going, allow the presently disclosed embodiments to provide significant advantages in the administration of a loyalty program. For example, the system 10 immediately identifies any of the following information relevant to the member 600 account and the current transaction:
a. Current member 600 offer pool (member's currently available rewards and marketing offers) and transaction timestamp;
b. Transaction product/service identifiers, descriptions, prices and quantities;
c. Gross transaction total; and
d. Offers from the merchant 650 or system 10 enrolled CPGs 640 (e.g., consumer product companies) producing the products being purchased that can be applied to the transaction.

The system 10, in real time, uses the eligibility rules engine to determine available offers and rewards, and then returns all identified offers for the current transaction, where the following occurs:
a. Marketing offers (general and targeted) are automatically applied to the transaction (including those targeted at specific individual products and services);
b. Reward offers are presented (through POS 160 interface and/or the terminal device 704) which allow the consumer 600 to either accept the reward at this time, or decline the reward so that it can be applied to a later transaction;
c. If accepted, the reward is applied to the transaction;
d. If declined, the reward is saved in member's account for future use.

The consumer 600 may elect to pay for the transaction through their system 10 account via a mobile payment process, as follows:
a. Member 600 is asked if he/she wishes to pay for the transaction through their system 10 account (only available after member registers for mobile payment capabilities);
b. If member declines, the member pays for the transaction through traditional means (i.e. cash, check, or credit or debit card swipe);
c. If member affirms, the system 10 asks the member to enter their PIN number, which is entered into the keypad of the terminal device 704/POS system 160 (if the setting is in a location where a tip may be added, the amount is totaled prior to the payment being processed);
d. The PIN number is transmitted to the system 10, along with the total amount of the purchase;
e. The system 10 interfaces with a financial institution to process the payment and responds to the terminal device 704/POS system 160 that the payment is processed; and
f. Payment is posted and the POS system 160 concludes the transaction.

The system 10 stores all applicable transaction details, along with any rewards and offers applied, in a transaction database that organizes purchase and account data across entities, including: Member 600, Merchant 650, and CPG 640 (such as consumer product companies). This allows for significantly rich data mining capabilities.

Using the system 10, CPGs 640 and merchants 650 may participate in various types of on-demand marketing promotions, such as:
a. May place general marketing offers onto the system 10, which are placed on the business's web portal 102, 104 where they are available for members 600 to see. Members 600 who mark the business as a favorite, which places it on their personal web portal 106 or mobile app 706, will see those offers on their page.
b. May place requests for targeted marketing campaigns by defining the business goals and constraints of the campaign. The system 10's analytics engine predicts customer behavior to group, score and identify the members with the highest propensity to respond to specific offers and makes recommendations that conform to the business objectives and constraints. The system 10 will also optimize channel delivery and provide personalized, targeted offers to its members 600.

Vendors 660 receive from the system 10 multi-dimensional reports that can be rolled up at any level they define (for example, store, region, franchise, etc.), including purchase information, member activity reports, product purchase analysis, demographic analyses, geographic analyses (for example, distance traveled by consumers), etc.

Vendors 660 receive from the system 10 marketing analyses reports providing member response rate information, as well as purchases made in addition to the specific offer(s).

CPGs 640 and Merchants 650 may create any design of loyalty program that suits their business, which is supported on the system 10 through a web-based loyalty program rules interface. The system 10's rules based system offers programs as simple as buy x get x free, to time based offers (buy x in 30 days and receive y free), to multi-level rewards (silver/gold/platinum) based upon the consumer's current status (e.g., based upon the level of prior qualifying purchases). Because the system 10 stores a record of the consumer's 600 past purchase history, it can automatically at the time of a transaction determine if the consumer 600 has met the particular business rule defining a reward for behavior that occurs over a period of time.

Merchants 650 can set different rules at different levels of the business. For example, a local fast food franchise owner could offer a local promotion that is only good at the franchise owner's 8 locations. Merchants 650 may redeem offers and rewards offered by their own business (e.g., higher levels of the merchant organization offering incentives to individual stores), or from CPGs 640 for specific products purchased by the member 600. The system 10 tracks all redemptions and provides accounting and invoicing for CPGs 640 to reimburse the merchant 650, and for higher levels of the merchant organization to reimburse individual stores (if that hierarchy is established for the business). The system 10 therefore allows incentives to be provided across levels of the same merchant 650 organization, or from a CPG 640 to a merchant 650, by tracking purchase data of consumers 600 in a consumer loyalty program.

Vendors 660 may order member surveys that are sent to members 600 based upon defined criteria, which may be accompanied by an offer if the survey is completed. The system 10 facilitates the online surveys, collects the results, and provides survey results and summarized scoring to the requesting vendor 660.

For purposes of clarity, the various databases shown in FIGS. 1-2 are referred to herein as individual databases. It will be appreciated that such databases each may comprise a plurality of databases operably connected by software that collectively are capable to perform the functions allocated to such a database according to the present disclosure. It also will be appreciated that one or more aggregated database may be configured by software to be operable to collectively perform the functions allocated to multiple databases according to the present disclosure

Likewise, for purposes of clarity, each server shown in FIGS. 1-2 is referred to herein as an individual server. Such servers need not, however, each be an individual server. Each such server may comprise a plurality of servers or other computing devices or systems connected by hardware and software that collectively are operable to perform the functions allocated thereto according to the present disclosure.

It will be appreciated that consumers 600, CPGs 640, merchants 650, and others interacting with system 10 do so by using one or more computers, computing devices, or computing systems, such as one or more mainframe computers, workstations, personal computers, laptop computers, hand-held computers, tablets, cellular phones, or computing devices. Such computers, computing devices, or computing systems each comprise a video display terminal (not shown) upon which information may be displayed in a manner perceptible by the user, and also may comprise an audio display means such as one or more loudspeakers. Such computers, computing devices, or computing systems each also comprise one or more data entry devices (not shown) operable by the user, such as, for example, a keyboard, keypad, pointing device, mouse, and/or microphone, as well as computer software including software for browsing the Internet and interpreting and displaying webpages.

The various functions of system 10, and the various configurations and programming recited herein and in the claims, may be performed by computer software and/or computer hardware. Such computer software may be written in a well known language such as, for example, Basic, C, C++, Fortran, JavaScript, Java, Pascal, PERL, HTML, XML, SQL, or .NET, or a combination of any of the foregoing or the equivalents thereof.

While various embodiments of a system for an integrated multi-vendor customer loyalty program and methods for using the same have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

What is claimed is:

1. A system for an integrated multi-vendor customer loyalty program for use with a point of sale terminal operative to record sales transaction data relating to a customer purchase, the system comprising:
a terminal device disposed near the point of sale terminal;
a wireless local area network;
a software adaptor executed by a data processor, the software adaptor operative to retrieve the sales transaction data and transmit the sales transaction data to the terminal device;
at least one database server comprising operational software and a plurality of consumer accounts and operably connected to the terminal device; and
a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts;
wherein the terminal device is operative to transmit the sales transaction data in real-time over the wireless local area network to the at least one database server to be recorded in at least one of the plurality of databases.

2. The system of claim 1, wherein the software adaptor is contained within the point of sale terminal.

3. The system of claim 1, wherein the software adaptor comprises a representational state transfer application programming interface.

4. The system of claim 1, wherein the terminal device is operatively coupled to the software adaptor for data communication by an interface selected from the group consisting of: universal serial bus, wireless communication, and Bluetooth wireless communication.

5. The system of claim 1, wherein the sales transaction data comprises product-level purchase information.

6. The system of claim 5, wherein the product-level purchase information is selected from the group consisting of: product identification, item unit quantity, item unit price, timestamp, merchant location, and transaction total.

7. The system of claim 1,
wherein the database server is operative to compare the sales transaction data to the operating parameters to determine if the customer is entitled to a reward and, if so, transmit reward information to the terminal device in real-time; and
wherein the terminal device is operative to transmit the reward information to the software adaptor in real-time; and
wherein the point of sale terminal is operative to apply the reward to the sales transaction prior to conclusion of the sales transaction.

8. The system of claim 1, wherein the terminal device is operative to receive loyalty program identification information from the customer.

9. The system of claim 1, wherein the at least one database server engages in HTTP request communication with the software adaptor through the wireless local area network and the terminal device.

10. A system for an integrated multi-vendor customer loyalty program for use with a point of sale system operative to record product level sales transaction data relating to a customer purchase of a market basket of goods/services, wherein the customer has a program status, the system comprising:
at least one database server comprising operational software and a plurality of consumer accounts;
a software adaptor executed by a data processor, the software adaptor operative to retrieve the product level sales transaction data and transmit the product level sales transaction data to the at least one database server; and
a plurality of databases on the at least one database server configured to manipulate and store the product level sales transaction data, to store operating parameters of a plurality of vendors' loyalty programs, determine the customer's offer and reward eligibility under the operating parameters given the customer program status and contents of the market basket, transmit back to the point of sale system, prior to completion of the customer purchase, offers and rewards for which the customer is eligible, and updating individual vendor-specific subaccounts linked to the customer to reflect the customer purchase.

11. The system of claim 10, further comprising:
a terminal device disposed near the point of sale system;
a wireless local area network;
wherein the software adaptor is operative to transmit the sales transaction data to the terminal device; and
wherein the terminal device is operative to transmit the product level sales transaction data in real-time over the wireless local area network to the at least one database server to be recorded in at least one of the plurality of databases.

12. The system of claim 10, wherein the software adaptor is integrated within the point of sale system.

13. The system of claim 10, wherein the software adaptor comprises a representational state transfer application programming interface.

14. The system of claim 11, wherein the terminal device is operatively coupled to the software adaptor for data communication by an interface selected from the group consisting of: universal serial bus, wireless communication, and Bluetooth wireless communication.

15. The system of claim 10, wherein the product level sales transaction data is selected from the group consisting of: product identification, item unit quantity, item unit price, timestamp, merchant location, and transaction total.

16. The system of claim 11,
wherein the database server is operative to compare the product level sales transaction data to the operating parameters to determine if the customer is entitled to a reward and, if so, transmit reward information to the terminal device in real-time; and
wherein the terminal device is operative to transmit the reward information to the software adaptor in real-time; and
wherein the point of sale terminal is operative to apply the reward to the sales transaction prior to conclusion of the sales transaction.

17. The system of claim 11, wherein the terminal device is operative to receive loyalty program identification information from the customer.

18. The system of claim 11, wherein the at least one database server engages in HTTP request communication with the software adaptor through the wireless local area network and the terminal device.

19. A method for using an integrated multi-vendor customer loyalty program in conjunction with a point of sale terminal operative to record sales transaction data relating to a customer purchase, the method comprising the steps of:
a) providing:
a terminal device disposed near the point of sale terminal;
a wireless local area network;
a software adaptor executed by a data processor, the software adaptor operative to retrieve the sales transaction data and transmit the sales transaction data to the terminal device;
at least one database server comprising operational software and a plurality of consumer accounts and operably connected to the terminal device; and
a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts;
wherein the terminal device is operative to transmit the sales transaction data in real-time over the wireless local area network to the at least one database server to be recorded in at least one of the plurality of databases;
b) recording the sales transaction data in a data mining and analytics database;
c) a first one of the plurality of vendors retrieving from the data mining and analytics database sales transaction data relating to a purchase of a second one of the plurality of vendors' products.

20. The method of claim 19, wherein the retrieved sales transaction data includes individual consumer identification.

21. The method of claim 19, wherein the retrieved sales transaction data includes individual vendor identification.

22. The method of claim 19, wherein the retrieved sales transaction data includes consumer identification only be demographics.

23. The method of claim 19, wherein the retrieved sales transaction data includes product identification only by product type.

24. A method for using an integrated multi-vendor customer loyalty program in conjunction with a point of sale terminal operative to record sales transaction data relating to a customer purchase, the method comprising the steps of:
a) providing:
a terminal device disposed near the point of sale terminal;
a wireless local area network;
a software adaptor executed by a data processor, the software adaptor operative to retrieve the sales transaction data and transmit the sales transaction data to the terminal device;
at least one database server comprising operational software and a plurality of consumer accounts and operably connected to the terminal device; and
a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts;
wherein the terminal device is operative to transmit the sales transaction data in real-time over the wireless local area network to the at least one database server to be recorded in at least one of the plurality of databases;
b) recording the sales transaction data in one of the plurality of databases;
c) establishing a predetermined rule in which a reward is given to a customer after the customer makes a predetermined number of predetermined purchases within a predetermined time period;
for each current customer purchase, analyzing in real-time sales transaction data from the current customer purchase and recorded sales transaction data from past customer purchases to determine if a reward has been earned under the predetermined rule; and
e) if a reward is determined at step (d) to have been earned, applying the reward in real-time to the current customer purchase.

25. The method of claim 24, wherein the reward comprises a free product.

26. A method for using an integrated multi-vendor customer loyalty program in conjunction with a point of sale terminal operative to record sales transaction data relating to a customer purchase of a supplier's product from a merchant, the method comprising the steps of:
a) providing:
a terminal device disposed near the point of sale terminal;
a wireless local area network;
a software adaptor executed by a data processor, the software adaptor operative to retrieve the sales transaction data and transmit the sales transaction data to the terminal device;
at least one database server comprising operational software and a plurality of consumer accounts and operably connected to the terminal device; and
a plurality of databases on the at least one database server configured to manipulate and store the sales transaction data, wherein consumers receive credits for sales transactions according to operating parameters of a plurality of vendors' loyalty programs, and the credits are recorded in individual consumer vendor-specific subaccounts;
wherein the terminal device is operative to transmit the sales transaction data in real-time over the wireless local area network to the at least one database server to be recorded in at least one of the plurality of databases;
b) recording the sales transaction data in one of the plurality of databases;
c) establishing a predetermined rule in which a reward is given to a merchant for purchases by customers of a predetermined number of the supplier's product;
d) for each current customer purchase, analyzing sales transaction data from the current customer purchase and/or recorded sales transaction data from past customer purchases to determine if a reward has been earned under the predetermined rule; and
e) if a reward is determined at step (d) to have been earned, applying the reward to an account for the merchant in one of the plurality of databases.

27. The method of claim 26, wherein the predetermined number is one.

28. The method of claim 26, wherein the reward is given to a merchant for purchases by customers of the predetermined number of the supplier's product within a predetermined time period.
